(19) United States
(12) Patent Application Publication
(10) Pub. No.: US 2026/0085568 A1
(43) Pub. Date: Mar. 26, 2026

(54) GESTURE DETECTION DEVICE AND GESTURE DETECTION METHOD

(71) Applicant: AISIN CORPORATION, Kariya, Aichi (JP)

(72) Inventors: Keiichi YANAI, Kariya-shi, Aichi-ken (JP); Yoshinori KOGURE, Kariya-shi, Aichi-ken (JP); Toshifumi YANAI, Kariya-shi, Aichi-ken (JP)

(73) Assignee: AISIN CORPORATION, Kariya, Aichi (JP)

(21) Appl. No.: 19/112,277

(22) PCT Filed: Oct. 27, 2023
(86) PCT No.: PCT/JP2023/038978

§ 371 Date: Mar. 17, 2025

(30) Foreign Application Priority Data
Nov. 7, 2022 (JP) 2022-178155

(51) Int. Cl. E05F 15/73

(52) U.S. Cl. CPC E05F 15/73; E05F 2015/767; E05Y 2400/86; E05Y 2900/531

(57) ABSTRACT

A gesture detection device (70) includes a position acquisition unit (73) configured to acquire a predetermined position that is a position of a body part of a user in an image captured by a camera (50) and a reference position, a direction determination unit (74) configured to determine whether the user faces an opening portion of a vehicle (10), and a gesture determination unit (75) configured to determine whether the user has made a gesture. The gesture determination unit (75) determines that the user has made a predetermined gesture for opening at least a door when the predetermined position is moved relative to the reference position in a predetermined direction corresponding to an opening direction of the door.

### CROSS REFERENCE TO RELATED APPLICATIONS

This application is a National Stage of International Application No. PCT/JP2023/038978, filed on Oct. 27, 2023, which claims priority from Japanese Patent Application No. 2022-178155, filed on Nov. 7, 2022, the entire contents of which are incorporated in their entirety.

### TECHNICAL FIELD

The present disclosure relates to a gesture detection device and a gesture detection method.

### BACKGROUND ART

JP 2019-105046A (Reference 1) discloses a door control system including a drive device that drives a rear door, a distance sensor that measures a distance to a hand of a user positioned in the vicinity of the rear door, and a control device that controls the drive device.

The door control system opens and closes the rear door when the user moves a hand approaching the rear door in an opening direction or a closing direction. At this time, the door control system performs follow-up control for causing a moving speed of the rear door to follow a moving speed of the hand of the user.

### CITATION LIST

### Patent Literature

Patent Literature 1: JP 2019-105046A

### SUMMARY OF THE DISCLOSURE

### Technical Problem

In the door control system as described above, when a user wants to board a vehicle quickly, the user can quickly open the rear door by quickly moving a hand approaching a door handle. However, the user cannot open the rear door until the user approaches the vehicle. The door control system as described above still has room for improvement in terms of improving convenience for a user.

### Solution to Problem

A gesture detection device according to an aspect disclosed here is applied to a vehicle including a vehicle body having an opening portion, a door configured to open and close the opening portion, a camera configured to image a user who faces the opening portion, and a door drive unit configured to drive the door, and the gesture detection device detects a gesture that triggers an operation of the door and is made by the user using a predetermined body part. A body part of the user different from the predetermined body part is a reference body part. The gesture detection device includes a position acquisition unit configured to acquire a predetermined position which is a position of the predetermined body part and a reference position which is a position of the reference body part in an image captured by the camera, a direction determination unit configured to determine whether the user faces the opening portion based on the reference position in the image, and a gesture determination unit configured to determine whether the user has made a gesture based on changes of the predetermined position and the reference position in a plurality of the images captured at different imaging times, when the direction determination unit determines that the user faces the opening portion. The gesture determination unit determines that the user has made a predetermined gesture for opening at least the door, when the predetermined position is moved relative to the reference position in a predetermined direction corresponding to an opening direction of the door.

A gesture detection method according to another aspect disclosed here is applied to a vehicle including a vehicle body having an opening portion, a door configured to open and close the opening portion, a camera configured to image a user who faces the opening portion, and a door drive unit configured to drive the door, and the gesture detection method detects a gesture that triggers an operation of the door and is made by the user using a predetermined body part. A body part of the user different from the predetermined body part is a reference body part. The gesture detection method includes a position acquisition step of acquiring a predetermined position which is a position of the predetermined body part and a reference position which is a position of the reference body part in an image captured by the camera, a direction determination step of determining whether the user faces the opening portion based on the reference position in the image, and a gesture determination step of determining whether the user has made a gesture based on changes of the predetermined position and the reference position in a plurality of the images captured at different imaging times, when it is determined in the direction determination step that the user faces the opening portion. The gesture determination step includes determining that the user has made a predetermined gesture for opening at least the door, when the predetermined position is moved relative to the reference position in a predetermined direction corresponding to an opening direction of the door.

### BRIEF DESCRIPTION OF DRAWINGS

FIG. 1 is a schematic diagram showing a vehicle according to an embodiment.

FIG. 2 shows an example of an image captured by a camera provided in the vehicle shown in FIG. 1.

FIG. 3 shows an example of an image of a user who makes a gesture using a right hand, which is captured by the camera provided in the vehicle shown in FIG. 1.

FIG. 4 shows an example of an image of a user who makes a gesture using a left hand, which is captured by the camera provided in the vehicle shown in FIG. 1.

FIG. 5 is a flowchart showing a flow of right outward gesture determination processing executed by a gesture determination unit provided in the vehicle shown in FIG. 1.

FIG. 6 is a flowchart showing a flow of right inward gesture determination processing executed by the gesture determination unit provided in the vehicle shown in FIG. 1.

### DESCRIPTION OF EMBODIMENTS

Hereinafter, an embodiment of a vehicle to which a gesture detection device and a gesture detection method are applied will be described with reference to the drawings.

### Configuration of Present Embodiment

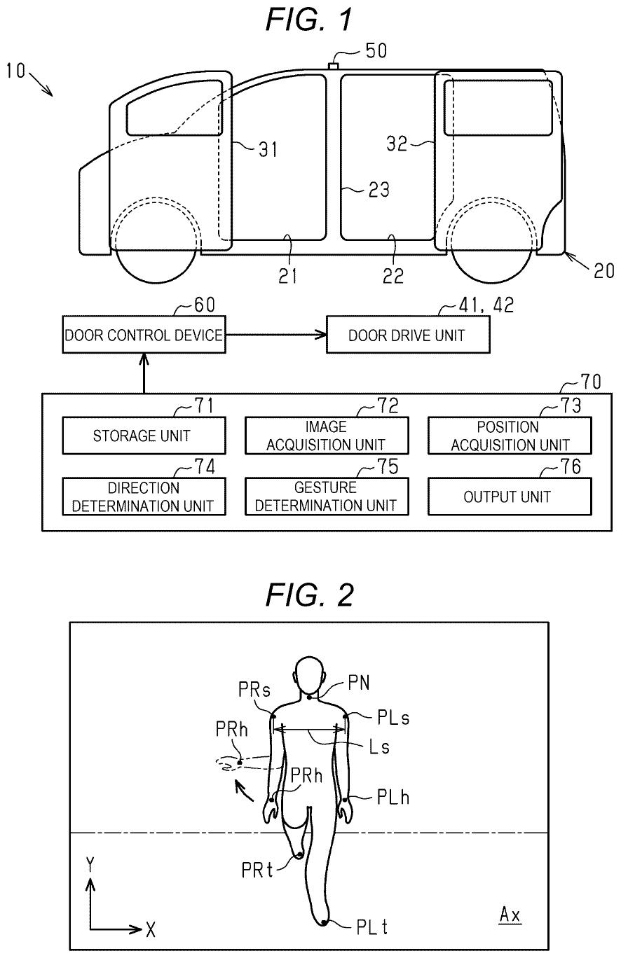

As shown in FIG. 1, a vehicle 10 includes a vehicle body 20, a front door 31, a rear door 32, a front door drive unit 41, a rear door drive unit 42, a camera 50, a door control device 60, and a gesture detection device 70. In the following description, a width direction of the vehicle 10, a front-rear direction of the vehicle 10, and an up-down direction of the vehicle 10 are simply referred to as a width direction, a front-rear direction, and an up-down direction, respectively. In the width direction, a direction away from the center of the vehicle 10 is also referred to as outward, and a direction approaching the center of the vehicle 10 is also referred to as inward.

### <Vehicle Body 20>

The vehicle body 20 includes a front opening portion 21 and a rear opening portion 22 that are open on a side surface. The vehicle body 20 includes a center pillar 23 that separates the front opening portion 21 and the rear opening portion 22 from each other. The front opening portion 21 and the rear opening portion 22 are adjacent to each other in the front-rear direction with the center pillar 23 interposed therebetween. The front opening portion 21 is positioned in front of the rear opening portion 22. The front opening portion 21 and the rear opening portion 22 are portions through which a user passes when the user gets on and off the vehicle 10. In the present embodiment, the front opening portion 21 corresponds to a “second opening portion”, and the rear opening portion 22 corresponds to a “first opening portion”.

### <Front Door 31 and Front Door Drive Unit 41>

The front door 31 has a shape corresponding to the front opening portion 21 when viewed in the width direction. The front door 31 slides in the front-rear direction relative to the vehicle body 20 so as to be displaced between a fully closed position where the front opening portion 21 is fully closed and a fully opened position where the front opening portion 21 is fully opened. An opening direction of the front door 31 is forward, and a closing direction of the front door 31 is rearward. That is, the opening direction of the front door 31 is a direction opposite to the closing direction of the front door 31. The front door drive unit 41 drives the front door 31. The front door drive unit 41 opens the front door 31 toward the fully opened position or closes the front door 31 toward the fully closed position. In the present embodiment, the front door 31 corresponds to a “second door”, and the front door drive unit 41 corresponds to a “door drive unit”.

### <Rear Door 32 and Rear Door Drive Unit 42>

The rear door 32 has a shape corresponding to the rear opening portion 22 when viewed in the width direction. The rear door 32 slides in the front-rear direction relative to the vehicle body 20 to be displaced between a fully closed position where the rear opening portion 22 is fully closed and a fully opened position where the rear opening portion 22 is fully opened. An opening direction of the rear door 32 is rearward, and a closing direction of the rear door 32 is forward. That is, the opening direction of the rear door 32 is a direction opposite to the closing direction of the rear door 32. The rear door drive unit 42 drives the rear door 32. The rear door drive unit 42 opens the rear door 32 toward the fully opened position or closes the rear door 32 toward the fully closed position. In the present embodiment, the rear door 32 corresponds to a “first door”, and the rear door drive unit 42 corresponds to a “door drive unit”.

### <Camera 50>

The camera 50 is installed above the center pillar 23 of the vehicle body 20 in a manner of facing outward in the width direction. That is, the camera 50 is disposed between the front opening portion 21 and the rear opening portion 22 in the front-rear direction. The camera 50 can image a region facing the front opening portion 21 and the rear opening portion 22 regardless of an opening and closing state of the front door 31 and the rear door 32. The camera 50 outputs a captured image to the gesture detection device 70 for each frame. A frame rate of the camera 50 may be, for example, about 30 fps. FIG. 2 shows an example of an image of a user facing the front opening portion 21 and the rear opening portion 22, which is captured by the camera 50. In the following description, facing the front opening portion 21 and the rear opening portion 22, in other words, facing the center pillar 23, is referred to as “facing a side surface of the vehicle 10”. When a user faces a left side surface of the vehicle 10, a right half body of the user faces the rear opening portion 22, and a left half body of the user faces the front opening portion 21.

### <Door Control Device 60>

The door control device 60 includes, for example, a processing circuit including a CPU and a memory. The memory includes a RAM, a ROM, and the like, and stores a program or a command configured to cause the CPU to execute processing. The memory, that is, a non-transitory computer readable medium includes any usable medium that can be accessed by a general-purpose or dedicated computer. The door control device 60 controls the front door drive unit 41 and the rear door drive unit 42 according to a program stored in the memory and an input command signal. Specifically, the door control device 60 opens the front door 31 when receiving an opening command signal for opening the front door 31. On the other hand, the door control device 60 closes the front door 31 when receiving a closing command signal for closing the front door 31. The door control device 60 opens the rear door 32 when receiving an opening command signal for opening the rear door 32. On the other hand, the door control device 60 closes the rear door 32 when receiving a closing command signal for closing the rear door 32.

### <Gesture Detection Device 70>

The gesture detection device 70 includes, for example, a processing circuit including a CPU and a memory. According to a program stored in the memory, the gesture detection device 70 determines whether a user has made a gesture using a body part, and outputs a command signal corresponding to the gesture to the door control device 60. That is, the gesture triggers an operation of the front door 31 and the rear door 32.

First, a gesture detected by the gesture detection device 70 will be described.

As shown in FIG. 2, a gesture detected by the gesture detection device 70 is a movement of an arm in a state where a user faces a side surface of the vehicle 10. In a state where the user faces the side surface of the vehicle 10, a face and an upper body of the user face the side surface of the vehicle 10. The gesture includes a movement of a right hand of the user in the opening and closing direction of the rear door 32 and a movement of a left hand of the user in the opening and closing direction of the front door 31.

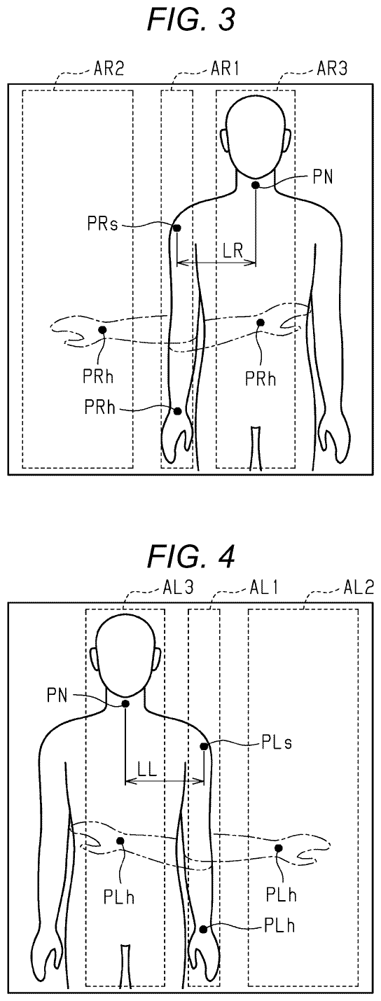

As shown in FIG. 3, gestures using a right hand include a right outward gesture that includes an action of moving the right hand outward of the body from a state where a user lowers the right hand, and a right inward gesture that includes an action of moving the right hand inward of the body from a state where the user lowers the right hand. In FIG. 3, the right outward gesture includes an action of the user moving the right hand from a position indicated by a solid line to a position indicated by a one-dot chain line. In FIG. 3, the right inward gesture includes an action of the user moving the right hand from the position indicated by the solid line to a position indicated by a two-dot chain line.

The right outward gesture further includes a right outward reverse gesture of moving the right hand to an original position after the right hand is moved outward of the body, and a right outward holding gesture of stopping the right hand after the right hand is moved outward of the body. When a user makes the right outward reverse gesture, the user moves the right hand from the position indicated by the solid line to the position indicated by the one-dot chain line, and then moves the right hand to the position indicated by the solid line. When a user makes the right outward holding gesture, the user moves the right hand from the position indicated by the solid line to the position indicated by the one-dot chain line and then keeps the right hand at the position indicated by the one-dot chain line. In the present embodiment, the right outward gesture corresponds to a “first gesture (first opening gesture)”, the right outward reverse gesture corresponds to a “third gesture”, and the right outward holding gesture corresponds to a “fourth gesture”.

The right inward gesture further includes a right inward reverse gesture of moving the right hand to the original position after the right hand is moved inward of the body, and a right inward holding gesture of stopping the right hand after the right hand is moved inward of the body. When a user makes the right inward reverse gesture, the user moves the right hand from the position indicated by the solid line to the position indicated by the two-dot chain line, and then moves the right hand to the position indicated by the solid line. When a user makes the right inward holding gesture, the user moves the right hand from the position indicated by the solid line to the position indicated by the two-dot chain line, and then keeps the right hand at the position indicated by the two-dot chain line. In the present embodiment, the right inward gesture corresponds to a “first closing gesture”.

As shown in FIG. 4, gestures using a left hand includes a left outward gesture including an action of moving the left hand outward of the body from a state where a user lowers the left hand, and a left inward gesture including an action of moving the left hand inward of the body from a state where the user lowers the left hand. In FIG. 4, the left outward gesture includes an action of the user moving the left hand from a position indicated by a solid line to a position indicated by a one-dot chain line. In FIG. 4, the left inward gesture includes an action of the user moving the left hand from the position indicated by the solid line to a position indicated by a two-dot chain line.

The left outward gesture further includes a left outward reverse gesture of moving the left hand to an original position after the left hand is moved outward of the body, and a left outward holding gesture of stopping the left hand after the left hand is moved outward of the body. When a user makes the left outward reverse gesture, the user moves the left hand from the position indicated by the solid line to the position indicated by the one-dot chain line, and then moves the left hand to the position indicated by the solid line. When a user makes the left outward holding gesture, the user moves the left hand from the position indicated by the solid line to the position indicated by the one-dot chain line, and then keeps the left hand at the position indicated by the one-dot chain line. In the present embodiment, the left outward gesture corresponds to a “second gesture (second opening gesture)”, the left outward reverse gesture corresponds to a “fifth gesture”, and the left outward holding gesture corresponds to a “sixth gesture”.

The left inward gesture further includes a left inward reverse gesture of moving the left hand to the original position after the left hand is moved inward of the body, and a left inward holding gesture of stopping the left hand after the left hand is moved inward of the body. When a user makes the left inward reverse gesture, the user moves the left hand from the position indicated by the solid line to the position indicated by the two-dot chain line, and then moves the left hand to the position indicated by the solid line. When a user makes the left inward holding gesture, the user moves the left hand from the position indicated by the solid line to the position indicated by the two-dot chain line, and then keeps the left hand at the position indicated by the two-dot chain line. In the present embodiment, the left inward gesture corresponds to a “second closing gesture”.

As shown in FIG. 1, when a user faces a left side surface of the vehicle 10, a right hand of the user faces the rear opening portion 22, and a left hand of the user faces the front opening portion 21. In this case, the right hand of the user corresponds to the rear door 32, and the left hand of the user corresponds to the front door 31. Accordingly, on the left side of the vehicle 10, a gesture using the right hand of the user is a gesture for opening and closing at least the rear door 32, and a gesture using the left hand of the user is a gesture for opening and closing at least the front door 31. Specifically, the right outward reverse gesture is a gesture for opening only the rear door 32 corresponding to the right hand, and the right outward holding gesture is a gesture for opening the front door 31 and the rear door 32. The left outward reverse gesture is a gesture for opening only the front door 31 corresponding to the left hand, and the left outward holding gesture is a gesture for opening the front door 31 and the rear door 32. On the other hand, the right inward reverse gesture is a gesture for closing only the rear door 32 corresponding to the right hand, and the right inward holding gesture is a gesture for closing the front door 31 and the rear door 32. The left inward reverse gesture is a gesture for closing only the front door 31 corresponding to the left hand, and the left inward holding gesture is a gesture for closing the front door 31 and the rear door 32.

On the other hand, when a user faces a right side surface of the vehicle 10, a right hand of the user faces the front opening portion 21, and a left hand of the user faces the rear opening portion 22. In this case, the right hand of the user corresponds to the front door 31, and the left hand of the user corresponds to the rear door 32. Accordingly, on the right side of the vehicle 10, a gesture using the right hand of the user is a gesture for opening and closing at least the front door 31, and a gesture using the left hand of the user is a gesture for opening and closing at least the rear door 32.

In the following description, it is assumed that a user makes a gesture in a state where the user faces the left side surface of the vehicle 10 in order to facilitate understanding of the description. That is, the gesture detection device 70 detects a gesture for opening and closing the front door 31 and the rear door 32 located on the left side of the vehicle 10.

Next, the gesture detection device 70 will be described for each function.

As shown in FIG. 1, the gesture detection device 70 includes a storage unit 71, an image acquisition unit 72, a position acquisition unit 73, a direction determination unit 74, a gesture determination unit 75, and an output unit 76.

### <Storage Unit 71>

The storage unit 71 stores a trained model obtained by machine learning using training data in which an image captured in advance and a position of a body part of a user are associated with each other. That is, the trained model is a model that receives an image captured by the camera 50 as an input and outputs a position of a body part of the user in the image. Specifically, the model outputs a user neck position PN, a right shoulder position PRs, a left shoulder position PLs, a right hand position PRh, a left hand position PLh, a right foot tip position PRt, and a left foot tip position PLt as shown in FIG. 2. In the present embodiment, the right hand corresponds to a “first body part”, the left hand corresponds to a “second body part”, and the neck, the right shoulder, and the left shoulder correspond to a “reference body part”. For example, the trained model is created at the time of designing the vehicle 10, and is written in the storage unit 71 at the time of manufacturing the gesture detection device 70.

Hereinafter, a method of creating the trained model will be described.

A method of creating the trained model includes a preparation step of preparing training data and a learning step of performing machine learning based on the training data. The preparation step includes an acquisition step of acquiring an image captured in a state where a user stands in an imaging area under various conditions, and a designation step of designating a position of a body part of the user in a plurality of images acquired in the acquisition step.

The acquisition step is performed using, for example, the actual vehicle 10. In the acquisition step, it is preferable to acquire many images captured by changing conditions related to the user and conditions related to an environment around the vehicle 10. Accordingly, it is possible to obtain a trained model that can be adapted to various situations, in other words, a trained model with high versatility. The designation step is a step of designating a position of a body part of the user in the acquired image. For example, coordinates using pixels in the image may be used for designating a position. In the present embodiment, an axis extending in a horizontal direction in the image is defined as an X axis, and an axis extending in a vertical direction in the image is defined as a Y axis.

The learning step is a step for creating a model by performing machine learning using a plurality of pieces of training data as learning data. Various methods can be selected as a method of the machine learning, such as a convolutional neural network (CNN). When the trained model receives a captured image, the trained model outputs the position of the body part of the user appearing in the image. On the other hand, when the trained model receives an image in which no body part of the user is captured, the trained model cannot output the position of the body part of the user. When accuracy of the trained model is not sufficient, the trained model may output a wrong position of the body part.

### <Image Acquisition Unit 72>

The image acquisition unit 72 acquires an image captured by the camera 50 for each imaging cycle of the camera 50. For example, when a frame rate of the camera 50 is 30 fps, the image acquisition unit 72 acquires an image captured by the camera 50 every 1/30 seconds.

### <Position Acquisition Unit 73>

The position acquisition unit 73 acquires a position of a body part of a user appearing in an image when the image captured by the camera 50 is input to the trained model stored in the storage unit 71. That is, the position acquisition unit 73 acquires the user neck position PN, the right shoulder position PRs, the left shoulder position PLs, the right hand position PRh, the left hand position PLh, the right foot tip position PRt, and the left foot tip position PLt. In the present embodiment, the right hand position PRh corresponds to a “first position”, the left hand position PLh corresponds to a “second position”, and the user neck position PN, the right shoulder position PRs, and the left shoulder position PLs correspond to a “reference position”.

### <Direction Determination Unit 74>

The direction determination unit 74 determines whether the user appearing in the image faces a side surface of the vehicle 10 based on the right shoulder position PRs and the left shoulder position PLs. Specifically, as shown in FIG. 2, the direction determination unit 74 determines whether the user faces the side surface of the vehicle 10 based on a shoulder width Ls that is a distance between the right shoulder position PRs and the left shoulder position PLs in an X direction.

When the user is on a side of the vehicle 10 and faces the side surface of the vehicle 10, the camera 50 images the user from the front. Therefore, the shoulder width Ls calculated by the direction determination unit 74 is a relatively large value. On the other hand, when the user is on a side of the vehicle 10 and faces slightly forward of the front opening portion 21 or slightly rearward of the rear opening portion 22, the camera 50 images the user from a right front side or a left front side. Therefore, the shoulder width Ls calculated by the direction determination unit 74 is a relatively small value.

Therefore, when the calculated shoulder width Ls is a preset shoulder width determination value Lsth or more, the direction determination unit 74 determines that the user faces the side surface of the vehicle 10. On the other hand, when the calculated shoulder width Ls is less than the shoulder width determination value Lsth, the direction determination unit 74 determines that the user does not face the side surface of the vehicle 10. The shoulder width determination value Lsth is a value set in advance through experiments and simulations.

When a distance from the camera 50 to the user is short, the shoulder width Ls is likely to be calculated as a large value, and when the distance from the camera 50 to the user is long, the shoulder width Ls is likely to be calculated as a small value. Therefore, the shoulder width determination value Lsth may be a variable value corresponding to the distance from the camera 50 to the user. The shoulder width Ls also changes corresponding to a physique size of a user. Therefore, when the direction determination unit 74 can determine a physique size of a user based on positions of a plurality of body parts, the shoulder width determination value Lsth may be a variable value corresponding to the physique of the user.

When the user is on a side of the vehicle 10 and faces a front side of the vehicle 10 or a rear side of the vehicle 10, the camera 50 images the user from a side. In this case, the position acquisition unit 73 cannot acquire both positions of the right shoulder position PRs and the left shoulder position PLs of the user. That is, the direction determination unit 74 cannot calculate the shoulder width Ls. When the position acquisition unit 73 cannot acquire at least one of the right shoulder position PRs and the left shoulder position PLs, in other words, when the direction determination unit 74 cannot calculate the shoulder width Ls, the direction determination unit 74 determines that the user does not face the side surface of the vehicle 10.

### <Gesture Determination Unit 75>

The gesture determination unit 75 executes approach determination processing of determining whether a user approaches the vehicle 10 and gesture determination processing of determining whether a user has made a gesture.

In the approach determination processing, the gesture determination unit 75 determines whether the right foot tip position PRt and the left foot tip position PLt of a user acquired by the position acquisition unit 73 are present in a determination area Ax as shown in FIG. 2. The determination area Ax is an area set in an image. In FIG. 2, the determination area Ax is an area below a line indicated by a one-dot chain line in the image. The determination area Ax may be a rectangular area or a semicircular area. A length of the determination area Ax in the X direction and the Y direction can be appropriately changed. When at least one of the right foot tip position PRt and the left foot tip position PLt of the user is present in the determination area Ax, the gesture determination unit 75 starts the gesture determination processing. The gesture determination unit 75 may start the approach determination processing only when the user carrying a portable device associated with the vehicle 10 approaches the vehicle 10. Accordingly, the gesture determination processing is prevented from being performed for a gesture of a person who is not the user of the vehicle 10.

In the gesture determination processing, the gesture determination unit 75 determines whether a user has made a gesture based on a position change of a body part in a plurality of consecutively captured images that are images captured at different imaging times. The gesture determination processing includes right outward gesture determination processing, right inward gesture determination processing, left outward gesture determination processing, and left inward gesture determination processing. The right outward gesture determination processing determines whether a user has made the right outward reverse gesture or the right outward holding gesture, and the right inward gesture determination processing determines whether a user has made the right inward reverse gesture or the right inward holding gesture. The left outward gesture determination processing determines whether a user has made the left outward reverse gesture or the left outward holding gesture, and the left inward gesture determination processing determines whether a user has made the left inward reverse gesture or the left inward holding gesture.

In the right outward gesture determination processing and the right inward gesture determination processing, the gesture determination unit 75 calculates a reference distance LR from the neck position PN to the right shoulder position PRs in the X direction based on the neck position PN and the right shoulder position PRs acquired by the position acquisition unit 73. As shown in FIG. 3, the gesture determination unit 75 sets a right reference area AR1, a right outer area AR2, and a right inner area AR3 in an image based on the neck position PN, the right shoulder position PRs, and the reference distance LR.

The right reference area AR1 is an area that includes the right shoulder position PRs and extends to the left and right from the right shoulder position PRs. A width of the right reference area AR1 is shorter than the reference distance LR. For example, the right reference area AR1 may be an area centered on the right shoulder position PRs, and the width of the right reference area AR1 may be about 40% of the reference distance LR. The right outer area AR2 is an area that is located on a right side of the right reference area AR1 and extends to the left and right. A width of the right outer area AR2 is longer than the reference distance LR. For example, the width of the right outer area AR2 may be about 140% of the reference distance LR. The right inner area AR3 is an area that includes the neck position PN and extends to the left and right from the neck position PN. A width of the right inner area AR3 is equal to the reference distance LR. For example, the right inner area AR3 may be an area centered on the neck position PN, and the width of the right inner area AR3 may be about 100% of the reference distance LR. A space not belonging to any area is preferably provided between the right reference area AR1 and the right outer area AR2 and between the right reference area AR1 and the right inner area AR3.

When a user makes a gesture while approaching the vehicle, the reference distance LR of the user viewed from the camera 50 changes over time. That is, the neck position PN and the right shoulder position PRs in an image change relative to an imaging time. Therefore, the reference distance LR is calculated each time a new image is captured, and the areas are set each time a new image is captured.

When setting of the areas is completed, the gesture determination unit 75 determines whether a user has made a gesture using a right hand based on a movement mode of the right hand position PRh of the user in the areas. Hereinafter, details will be described.

In the right outward gesture determination processing, the gesture determination unit 75 determines that a user has made the right outward reverse gesture when the user moves the right hand position PRh from the right reference area AR1 to the right outer area AR2 and then returns the right hand position PRh to the right reference area AR1 over time. In other words, the gesture determination unit 75 determines that the user has made the right outward reverse gesture when the user moves the right hand position PRh in an opening direction of the rear door 32 and then moves the right hand position PRh in a closing direction of the rear door 32. The gesture determination unit 75 determines that the user has made the right outward holding gesture when the user moves the right hand position PRh from the right reference area AR1 to the right outer area AR2 and then keeps the right hand position PRh in the right outer area AR2 over time. In other words, the gesture determination unit 75 determines that the user has made the right outward holding gesture when the user moves the right hand position PRh in the opening direction of the rear door 32 and then stops the right hand position PRh. In terms of this point, in the present embodiment, the opening direction of the rear door 32 corresponds to a “first direction” corresponding to the opening direction of the rear door 32.

In the right inward gesture determination processing, the gesture determination unit 75 determines that a user has made the right inward reverse gesture when the user moves the right hand position PRh from the right reference area AR1 to the right inner area AR3 and then returns the right hand position PRh to the right reference area AR1 over time. In other words, the gesture determination unit 75 determines that the user has made the right inward reverse gesture when the user moves the right hand position PRh in the closing direction of the rear door 32 and then moves the right hand position PRh in the opening direction of the rear door 32. The gesture determination unit 75 determines that the user has made the right inward holding gesture when the user moves the right hand position PRh from the right reference area AR1 to the right inner area AR3 and then keeps the right hand position PRh in the right inner area AR3 over time. In other words, the gesture determination unit 75 determines that the user has made the right inward holding gesture when the user moves the right hand position PRh in the closing direction of the rear door 32 and then stops the right hand position PRh.

As described above, in the present embodiment, the right reference area AR1, the right outer area AR2, and the right inner area AR3 are set based on the neck position PN and the right shoulder position PRs. Therefore, movement of the right hand position PRh to a right adjacent area is synonymous with movement of the right hand position PRh in the opening direction of the rear door 32 relative to the neck position PN and the right shoulder position PRs. Further, movement of the right hand position PRh to a left adjacent area is synonymous with movement of the right hand position PRh in the closing direction of the rear door 32 relative to the neck position PN and the right shoulder position PRs.

In the left outward gesture determination processing and the left inward gesture determination processing, the gesture determination unit 75 calculates a reference distance LL from the neck position PN to the left shoulder position PLs in the X direction based on the neck position PN and the left shoulder position PLs acquired by the position acquisition unit 73. As shown in FIG. 4, the gesture determination unit 75 sets a left reference area AL1, a left outer area AL2, and a left inner area AL3 in an image based on the neck position PN, the left shoulder position PLs, and the reference distance LL.

The left reference area AL1 is an area that includes the left shoulder position PLs and extends to the left and right from the left shoulder position PLs. A width of the left reference area AL1 is shorter than the reference distance LL. For example, the left reference area AL1 may be an area centered on the left shoulder position PLs, and the width of the left reference area AL1 may be about 40% of the reference distance LL. The left outer area AL2 is an area that is located on a left side of the left reference area AL1 and extends to the left and right. A width of the left outer area AL2 is longer than the reference distance LL. For example, the width of the left outer area AL2 may be about 140% of the reference distance LL. The left inner area AL3 is an area that includes the neck position PN and extends to the left and right from the neck position PN. A width of the left inner area AL3 is equal to the reference distance LL. For example, the left inner area AL3 may be an area centered on the neck position PN, and the width of the left inner area AL3 may be about 100% of the reference distance LL. When the reference distance LL and the reference distance LR in an image are equal, the left inner area AL3 overlaps the right inner area AR3. A space not belonging to any area is preferably provided between the left reference area AL1 and the left outer area AL2 and between the left reference area AL1 and the left inner area AL3.

When a user makes a gesture while approaching the vehicle, the reference distance LL of the user viewed from the camera 50 changes over time. That is, the neck position PN and the left shoulder position PLs in an image change relative to an imaging time. Therefore, the reference distance LL is calculated each time a new image is captured, and the areas are set each time a new image is captured.

When setting of the areas is completed, the gesture determination unit 75 determines whether a user has made a gesture using a left hand based on a movement mode of the left hand position PLh of the user in the areas. Hereinafter, details will be described.

In the left outward gesture determination processing, the gesture determination unit 75 determines that a user has made the left outward reverse gesture when the user moves the left hand position PLh from the left reference area AL1 to the left outer area AL2 and then returns the left hand position PLh to the left reference area AL1 over time. In other words, the gesture determination unit 75 determines that the user has made the left outward reverse gesture when the user moves the left hand position PLh in an opening direction of the front door 31 and then moves the left hand position PLh in a closing direction of the front door 31. The gesture determination unit 75 determines that the user has made the left outward holding gesture when the user moves the left hand position PLh from the left reference area AL1 to the left outer area AL2 and then keeps the left hand position PLh in the left outer area AL2 over time. In other words, the gesture determination unit 75 determines that the user has made the left outward holding gesture when the user moves the left hand position PLh in the opening direction of the front door 31 and then stops the left hand position PLh. In terms of this point, in the present embodiment, the opening direction of the front door 31 corresponds to a “second direction”corresponding to the opening direction of the front door 31.

In the left inward gesture determination processing, the gesture determination unit 75 determines that a user has made the left inward reverse gesture when the user moves the left hand position PLh from the left reference area AL1 to the left inner area AL3 and then returns the left hand position PLh to the left reference area AL1 over time. In other words, the gesture determination unit 75 determines that the user has made the left inward reverse gesture when the user moves the left hand position PLh in the closing direction of the front door 31 and then moves the left hand position PLh in the opening direction of the front door 31. The gesture determination unit 75 determines that the user has made the left inward holding gesture when the user moves the left hand position PLh from the left reference area AL1 to the left inner area AL3 and then keeps the left hand position PLh in the left inner area AL3 over time. In other words, the gesture determination unit 75 determines that the user has made the left inward holding gesture when the user moves the left hand position PLh in the closing direction of the front door 31 and then stops the left hand position PLh.

As described above, in the present embodiment, the left reference area AL1, the left outer area AL2, and the left inner area AL3 are set based on the neck position PN and the left shoulder position PLs. Therefore, movement of the left hand position PLh to a left adjacent area is synonymous with movement of the left hand position PLh in the opening direction of the front door 31 relative to the neck position PN and the left shoulder position PLs. Further, movement of the left hand position PLh to a right adjacent area is synonymous with movement of the left hand position PLh in the closing direction of the front door 31 relative to the neck position PN and the left shoulder position PLs.

### <Output Unit 76>

When it is determined that the user has made the right outward reverse gesture, the output unit 76 outputs an opening command signal for opening the rear door 32 corresponding to the right hand. When it is determined that the user has made the right outward holding gesture, the output unit 76 outputs an opening command signal for opening the front door 31 and the rear door 32. On the other hand, when it is determined that the user has made the right inward reverse gesture, the output unit 76 outputs a closing command signal for closing the rear door 32 corresponding to the right hand. When it is determined that the user has made the right inward holding gesture, the output unit 76 outputs a closing command signal for closing the front door 31 and the rear door 32.

When it is determined that the user has made the left outward reverse gesture, the output unit 76 outputs an opening command signal for opening the front door 31 corresponding to the left hand. When it is determined that the user has made the left outward holding gesture, the output unit 76 outputs an opening command signal for opening the front door 31 and the rear door 32. On the other hand, when it is determined that the user has made the left inward reverse gesture, the output unit 76 outputs a closing command signal for closing the front door 31 corresponding to the left hand. When it is determined that the user has made the left inward holding gesture, the output unit 76 outputs a closing command signal for closing the front door 31 and the rear door 32.

That is, when the gesture determination unit 75 determines that the user has made the right outward holding gesture and the left outward holding gesture, the output unit 76 outputs the same signal. When the gesture determination unit 75 determines that the user has made the right inward holding gesture and the left inward holding gesture, the output unit 76 outputs the same signal.

### <Processing Executed by Gesture Detection Device 70>

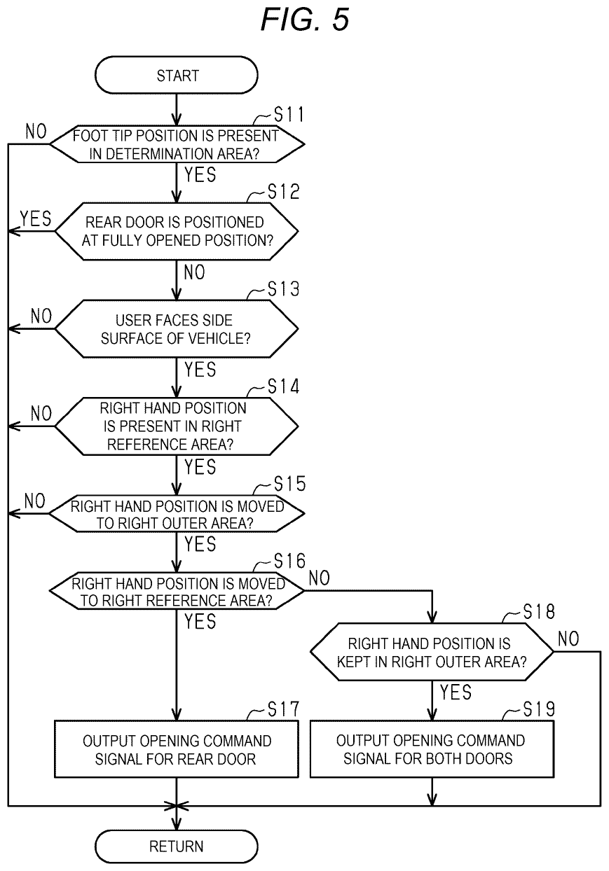

Hereinafter, a flow of the right outward gesture determination processing for determining whether a user has made the right outward reverse gesture or the right outward holding gesture will be described with reference to a flowchart shown in FIG. 5. The right outward gesture determination processing is processing executed for each predetermined control cycle when a user is present in an imaging area of the camera 50. In the flowchart shown in FIG. 5, in a step of performing determination using a position of a body part or performing determination using the right reference area AR1 and the right outer area AR2, for a newly acquired image, the position of the body part is acquired again or the areas are reset.

The right outward gesture determination processing is substantially the same as the left outward gesture determination processing for determining whether a user has made the left outward reverse gesture or the left outward holding gesture, except that a hand used for making a gesture is different and a door to be opened is different. Therefore, description of the left outward gesture determination processing is omitted.

As shown in FIG. 5, the gesture detection device 70 determines whether the right foot tip position PRt and the left foot tip position PLt in a newly captured image are present in a determination area Ax (S11). When neither the right foot tip position PRt nor the left foot tip position PLt is present in the determination area Ax (S11: NO), the gesture detection device 70 temporarily ends the present processing. On the other hand, when at least one position of the right foot tip position PRt and the left foot tip position PLt is present in the determination area Ax (S11: YES), the gesture detection device 70 determines whether the rear door 32 is positioned at the fully opened position (S12). When the rear door 32 is positioned at the fully opened position (S12: YES), in other words, when it is not necessary to open the rear door 32, the gesture detection device 70 temporarily ends the present processing.

On the other hand, when the rear door 32 is not positioned at the fully opened position (S12: NO), the gesture detection device 70 determines whether the user faces the side surface of the vehicle 10 based on the shoulder width Ls that is a distance between the right shoulder position PRs and the left shoulder position PLs (S13). When the user does not face the side surface of the vehicle 10 (S13: NO), the gesture detection device 70 temporarily ends the present processing. On the other hand, when the user faces the side surface of the vehicle 10 (S13: YES), the gesture detection device 70 determines whether the right hand position PRh is present in the right reference area AR1 (S14).

When the right hand position PRh is not present in the right reference area AR1 (S14), the gesture detection device 70 temporarily ends the present processing. On the other hand, when the right hand position PRh is present in the right reference area AR1 (S14: YES), the gesture detection device 70 determines whether the right hand position PRh is moved to the right outer area AR2 within a first determination time T1 (S15). Here, “within the first determination time T1” refers to that an elapsed time from a timing at which an affirmative determination is made in step S14 is within the first determination time T1. In step S15, the movement determination of the right hand position PRh is repeatedly performed for a newly captured image.

When the right hand position PRh is not moved to the right outer area AR2 within the first determination time T1 (S15: NO), the gesture detection device 70 temporarily ends the present processing. On the other hand, when the right hand position PRh is moved to the right outer area AR2 within the first determination time T1 (S15: YES), the gesture detection device 70 determines whether the right hand position PRh is moved to the right reference area AR1 within a second determination time T2 (S16). Here, “within the second determination time T2” refers to that an elapsed time from a timing at which the right hand position PRh is moved to the right outer area AR2 is within the second determination time T2. In step S16, the movement determination of the right hand position PRh is repeatedly performed for a newly captured image in a similar manner to step S15.

When the right hand position PRh is moved to the right reference area AR1 within the second determination time T2 (S16: YES), that is, when the user makes the right outward reverse gesture, the gesture detection device 70 outputs an opening command signal for the rear door 32 to the door control device 60 (S17). Thereafter, the gesture detection device 70 ends the present processing. On the other hand, when the right hand position PRh is not moved to the right reference area AR1 within the second determination time T2 (S16: NO), the gesture detection device 70 determines whether the right hand position PRh is present in the right outer area AR2 for a third determination time T3 (S18). Here, the third determination time T3 refers to that an elapsed time from a timing at which the right hand position PRh is moved to the right outer area AR2 is the third determination time T3. Therefore, the third determination time T3 is longer than the second determination time T2. In step S18, the movement determination of the right hand position PRh is repeatedly performed for a newly captured image in a similar manner to step S15.

When the right hand position PRh is not present in the right outer area AR2 for the third determination time T3 (S18: NO), that is, when the right hand position PRh is moved out of the right outer area AR2 within the third determination time T3, the gesture detection device 70 temporarily ends the present processing. On the other hand, when the right hand position PRh is kept in the right outer area AR2 for the third determination time T3 (S18: YES), the gesture detection device 70 outputs an opening command signal for the front door 31 and the rear door 32 (S19). A case where an affirmative determination is made in step S18 is a case where it is determined that the user has made the right outward holding gesture. Thereafter, the gesture detection device 70 ends the present processing.

In the flowchart shown in FIG. 5, steps S11, S14 to S16, and S18 include a “position acquisition step”, step S13 corresponds to a “direction determination step”, and steps S14 to S16, and S18 correspond to a “gesture determination step”.

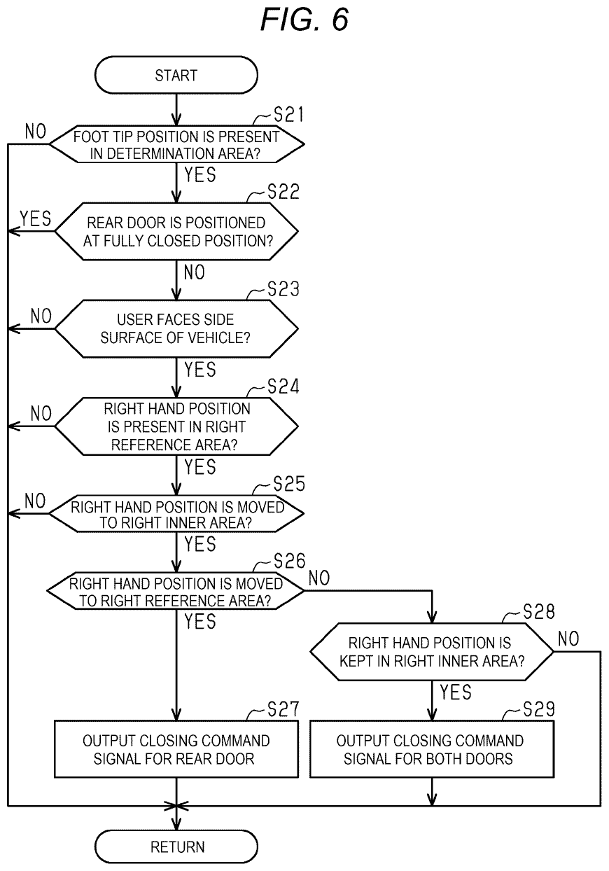

Hereinafter, a flow of the right inward gesture determination processing for determining whether a user has made the right inward reverse gesture or the right inward holding gesture will be described with reference to the flowchart shown in FIG. 6. The right inward gesture determination processing is processing executed for each predetermined control cycle when a user is present in an imaging area of the camera 50. In the flowchart shown in FIG. 6, in a step of performing determination using a position of a body part or performing determination using the right reference area AR1 and the right inner area AR3, for a newly acquired image, the position of the body part is acquired again or the areas are reset.

The right inward gesture determination processing is substantially the same as the left inward gesture determination processing for determining whether a user has made the left inward reverse gesture or the left inward holding gesture, except that a hand used for making a gesture is different and a door to be closed is different. Therefore, description of the left inward gesture determination processing is omitted.

As shown in FIG. 6, the gesture detection device 70 determines whether the right foot tip position PRt and the left foot tip position PLt in a newly captured image are present in a determination area Ax (S21). When neither the right foot tip position PRt nor the left foot tip position PLt is present in the determination area Ax (S21: NO), the gesture detection device 70 temporarily ends the present processing. On the other hand, when at least one position of the right foot tip position PRt and the left foot tip position PLt is present in the determination area Ax (S21: YES), the gesture detection device 70 determines whether the rear door 32 is positioned at the fully closed position (S22). When the rear door 32 is positioned at the fully closed position (S22: YES), in other words, when it is not necessary to close the rear door 32, the gesture detection device 70 temporarily ends the present processing.

On the other hand, when the rear door 32 is not positioned at the fully closed position (S22: NO), the gesture detection device 70 determines whether the user faces the side surface of the vehicle 10 based on the shoulder width Ls that is a distance between the right shoulder position PRs and the left shoulder position PLs (S23). When the user does not face the side surface of the vehicle 10 (S23: NO), the gesture detection device 70 temporarily ends the present processing. On the other hand, when the user faces the side surface of the vehicle 10 (S23: YES), the gesture detection device 70 determines whether the right hand position PRh is present in the right reference area AR1 (S24).

When the right hand position PRh is not present in the right reference area AR1 (S24: NO), the gesture detection device 70 temporarily ends the present processing. On the other hand, when the right hand position PRh is present in the right reference area AR1 (S24: YES), the gesture detection device 70 determines whether the right hand position PRh is moved to the right inner area AR3 within the first determination time T1 (S25). Here, “within the first determination time T1” refers to that an elapsed time from a timing at which an affirmative determination is made in step S24 is within the first determination time T1. In step S25, the movement determination of the right hand position PRh is repeatedly performed for a newly captured image.

When the right hand position PRh is not moved to the right inner area AR3 within the first determination time T1 (S25: NO), the gesture detection device 70 temporarily ends the present processing. On the other hand, when the right hand position PRh is moved to the right inner area AR3 within the first determination time T1 (S25: YES), the gesture detection device 70 determines whether the right hand position PRh is moved to the right reference area AR1 within the second determination time T2 (S26). Here, “within the second determination time T2” refers to that an elapsed time from a timing at which the right hand position PRh is moved to the right inner area AR3 is within the second determination time T2. In step S26, the movement determination of the right hand position PRh is repeatedly performed for a newly captured image in a similar manner to step S25.

When the right hand position PRh is moved to the right reference area AR1 within the second determination time T2 (S26: YES), that is, when the user makes the right inward reverse gesture, the gesture detection device 70 outputs a closing command signal for the rear door 32 to the door control device 60 (S27). Thereafter, the gesture detection device 70 ends the present processing. On the other hand, when the right hand position PRh is not moved to the right reference area AR1 within the second determination time T2 (S26: NO), the gesture detection device 70 determines whether the right hand position PRh is present in the right inner area AR3 for the third determination time T3 (S28). Here, the third determination time T3 refers to that an elapsed time from a timing at which the right hand position PRh is moved to the right inner area AR3 is the third determination time T3. Therefore, the third determination time T3 is longer than the second determination time T2. In step S28, the movement determination of the right hand position PRh is repeatedly performed for a newly captured image in a similar manner to step S25.

When the right hand position PRh is not present in the right inner area AR3 for the third determination time T3 (S28: NO), that is, when the right hand position PRh is moved out of the right inner area AR3 within the third determination time T3, the gesture detection device 70 temporarily ends the present processing. On the other hand, when the right hand position PRh is kept in the right inner area AR3 for the third determination time T3 (S28: YES), the gesture detection device 70 outputs a closing command signal for the front door 31 and the rear door 32 (S29). A case where an affirmative determination is made in step S28 is a case where it is determined that the user has made the right inward holding gesture. Thereafter, the gesture detection device 70 ends the present processing.

In the flowchart shown in FIG. 6, steps S21, S24 to S26, and S28 include a “position acquisition step”, step S23 corresponds to a “direction determination step”, and steps S24 to S26, and S28 correspond to a “gesture determination step”.

### Function of Present Embodiment

A function when a door of the stopped vehicle 10 is to be opened will be described. When a user wants to open the rear door 32 of the vehicle 10, the user makes the right outward reverse gesture while walking toward a left side surface of the vehicle 10. That is, the user moves a right hand close to the rear door 32 in the opening direction of the rear door 32, and then returns the right hand to an original position. Then, the rear door 32 is opened. On the other hand, when the user wants to open the front door 31 of the vehicle 10, the user makes the left outward reverse gesture while walking toward the left side surface of the vehicle 10. That is, the user moves a left hand close to the front door 31 in the opening direction of the front door 31, and then returns the left hand to an original position. Then, the front door 31 is opened.

When the user wants to open both the front door 31 and the rear door 32 of the vehicle 10, the user makes the right outward holding gesture or the left outward holding gesture while walking toward a side surface of the vehicle 10. That is, the user moves the right hand in the opening direction of the rear door 32 and then stops the right hand, or moves the left hand in the opening direction of the front door 31 and then stops the left hand. Then, the front door 31 and the rear door 32 are opened.

### Effects of Present Embodiment

(1) When a user opens the rear door 32, the user makes the right outward reverse gesture in a state where the user faces the left side surface of the vehicle 10. That is, when the user opens the rear door 32, the user makes a gesture including an action of moving the right hand close to the rear door 32 in the opening direction of the rear door 32. When the user opens the front door 31, the user makes the left outward reverse gesture in a state where the user faces the left side surface of the vehicle 10. That is, when the user opens the front door 31, the user makes a gesture including an action of moving the left hand close to the front door 31 in the opening direction of the front door 31. In this manner, when the user wants to open one door of the two doors, the user may make a gesture using a hand close to the one door, and may make a gesture by moving the hand in an opening direction of the one door. Therefore, the gesture detection device 70 can improve convenience for a user.

When it is determined that the user faces a side surface of the vehicle 10, the gesture detection device 70 starts determining whether the user has made a gesture. Therefore, the gesture detection device 70 can reduce the possibility of erroneously determining that a user has made a gesture based on a movement of a person passing by a side of the vehicle 10 while waving an arm.
(2) When a user makes a gesture while approaching the vehicle 10, the right hand position PRh and the left hand position PLh in an image are changed because the user makes a gesture and the user approaches the vehicle 10. In terms of this point, the gesture detection device 70 determines whether the user has made a gesture based on changes of the right hand position PRh and the left hand position PLh relative to the neck position PN, the right shoulder position PRs, and the left shoulder position PLs. Therefore, the gesture detection device 70 can accurately determine whether the user has made a gesture when the user makes a gesture while approaching the vehicle 10 and when the user stops and makes a gesture.
(3) The gesture detection device 70 outputs an opening command signal for the rear door 32 when the gesture detection device 70 determines that the user has made the right outward reverse gesture. The gesture detection device 70 outputs an opening command signal for the front door 31 when the gesture detection device 70 determines that the user has made the left outward determination gesture. Each of the right outward reverse gesture and left outward reverse gesture includes an action of moving the right hand or left hand in one direction and an action of returning the right hand or left hand to an original position. Therefore, as compared with a case where a gesture for opening the front door 31 and the rear door 32 is only an action of moving the right hand or the left hand in one direction, the gesture detection device 70 is less likely to erroneously determine a gesture.
(4) The gesture detection device 70 outputs an opening command signal for the front door 31 and the rear door 32 when the gesture detection device 70 determines that the user has made the right outward holding gesture or when the gesture detection device 70 determines that the user has made the left outward holding gesture. Each of the right outward holding gesture and the left outward holding gesture includes an action of moving the right hand or the left hand in one direction and an action of keeping the right hand or the left hand. Therefore, as compared with a case where a gesture for opening the front door 31 and the rear door 32 is only an action of moving the right hand or the left hand in one direction, the gesture detection device 70 is less likely to erroneously determine a gesture.
(5) The user can select to open only the rear door 32 or open both the front door 31 and the rear door 32 by selectively using the right outward reverse gesture and the right outward holding gesture. The user can select to open only the front door 31 or open both the front door 31 and the rear door 32 by selectively using the left outward reverse gesture and the left outward holding gesture. Therefore, the gesture detection device 70 can further improve convenience for a user.
(6) The gesture detection device 70 determines whether a user faces a side surface of the vehicle 10 based on the shoulder width Ls that is a distance between the right shoulder position PRs and the left shoulder position PLs. Therefore, the gesture detection device 70 can accurately determine whether the user faces the side surface of the vehicle 10.
(7) In the above description of effects, effects are described in a case where the user makes the right outward reverse gesture, the right outward holding gesture, the left outward reverse gesture, and the left outward holding gesture in order to open at least one of the front door 31 and the rear door 32. These effects are also achieved in a case where the user makes the right inward reverse gesture, the right inward holding gesture, the left inward reverse gesture, and the left inward holding gesture in order to close at least one of the front door 31 and the rear door 32. The gesture detection device 70 can open or close the front door 31 and the rear door 32 according to a movement direction of a hand of the user.
(8) Since the camera 50 is installed between the front opening portion 21 and the rear opening portion 22, when the camera 50 images a user facing a side surface of the vehicle 10, a right half body and a left half body of the user tend to be evenly reflected in an image. Therefore, the gesture detection device 70 can easily acquire the right hand position PRh, the right shoulder position PRs, the right foot tip position PRt, the left hand position PLh, the left shoulder position PLs, and the left foot tip position PLt.

The present embodiment can be modified as follows. The present embodiment and the following modifications can be combined with one another without technical contradiction.
A body part of a user used to make a gesture can be appropriately changed. The first body part is preferably a part of a right half body of the user that is easily moved independently by the user. For example, the first body part may be a right toe tip of the user. The second body part is preferably a part of a left half body of the user that is easily moved independently by the user. For example, the second body part may be a left toe tip of the user. The reference body part may be a body part on a center line of the body of the user. For example, the reference body part may be a face of the user or a chest of the user instead of the neck of the user.
The direction determination unit 74 may determine whether a user faces a side surface of the vehicle 10 by another determination method. Hereinafter, some examples will be described.
The direction determination unit 74 may determine that the user faces the side surface of the vehicle 10 when the right shoulder position PRs is present on one side of the neck position PN and the left shoulder position PRs is present on the other side of the neck position PN in the X direction. On the other hand, the direction determination unit 74 may determine that the user does not face the side surface of the vehicle 10 when the right shoulder position PRs or the left shoulder position PLs is present only on one side of the neck position PN in the X direction. However, even when the right shoulder position PRs and the left shoulder position PRs are present on both sides of the neck position PN, a middle position between the right shoulder position PRs and the left shoulder position PLs may deviate from the neck position PN in the X direction. In this case, the direction determination unit 74 may determine that the user does not face the side surface of the vehicle 10.
The direction determination unit 74 may determine whether the user faces the side surface of the vehicle 10 based on positions of body parts excluding the right shoulder and the left shoulder. For example, the direction determination unit 74 may determine whether the user faces the side surface of the vehicle 10 based on a right eye position and a left eye position of the user. The direction determination unit 74 may determine whether the user faces the side surface of the vehicle 10 based on a right ear position and a left ear position of the user.
The direction determination unit 74 may determine that the user faces the side surface of the vehicle 10 in a case where all positions of a plurality of body parts, which can be imaged by the camera 50 when the user faces the side surface of the vehicle 10, can be acquired. For example, the direction determination unit 74 may determine that the user faces the side surface of the vehicle 10 when all of the neck position PN, the right shoulder position PRs, the left shoulder position PLs, the right hand position PRh, the left hand position PLh, the right foot tip position PRt, and the left foot tip position PLt of the user can be acquired.
The gesture determination unit 75 may not set the right reference area AR1 and the right outer area AR2 in the right outward gesture determination processing. In this case, the gesture determination unit 75 calculates the reference distance LR that is a distance from the neck position PN to the right shoulder position PRs in the X direction and a comparison distance which is a distance from the neck position PN to the right hand position PRh in the X direction. Then, the gesture determination unit 75 determines a state of the right hand of the user based on a magnitude relationship between the reference distance LR and the comparison distance. Specifically, the gesture determination unit 75 determines that the user has moved the right hand in the opening direction of the rear door 32 when the comparison distance becomes sufficiently larger than the reference distance LR from a state where the comparison distance is substantially equal to the reference distance LR. In this manner, the gesture determination unit 75 may determine whether the user has made a gesture by comparing the distances. The same applies to the right inward gesture determination processing, the left outward gesture determination processing, and the left inward gesture determination processing.
A gesture to be determined by the gesture determination unit 75 may include at least the right outward reverse gesture and the left outward reverse gesture.
When it is determined that a user has made the right outward reverse gesture, the output unit 76 may output an opening command signal for opening the front door 31 and the rear door 32. When it is determined that the user has made the right outward holding gesture, the output unit 76 may output an opening command signal for opening the rear door 32 corresponding to the right hand. When it is determined that the user has made the right inward reverse gesture, the output unit 76 may output a closing command signal for closing the front door 31 and the rear door 32. When it is determined that the user has made the right inward holding gesture, the output unit 76 may output an opening command signal for closing the rear door 32 corresponding to the right hand. The same applies to a case where the user makes the left outward reverse gesture, the left outward holding gesture, the left inward reverse gesture, and the left outward holding gesture.
A gesture of a user for opening the rear door 32 may be a gesture that the user simply moves the right hand lowered downward to the right. In this case, the gesture determination unit 75 may determine that the user has made the gesture when the user moves the right hand position PRh from the right reference area AR1 to the right outer area AR2. The same applies to a gesture of the user for opening the front door 31.
A gesture of a user for opening the rear door 32 may be a gesture that the user simply moves the right hand lowered downward upward. In this case, an upward direction which is a movement direction of the right hand of the user corresponds to the “first direction” corresponding to the opening direction of the rear door 32. That is, the “first direction” does not need to be a direction the same as the opening direction of the rear door 32. The same applies to a gesture of the user for opening the front door 31.
The vehicle body 20 may not include the center pillar 23. In this case, the front opening portion 21 and the rear opening portion 22 may be integrated into one opening portion. That is, a front portion of the one opening portion corresponds to the front opening portion 21, and a rear portion of the one opening portion corresponds to the rear opening portion 22.
For example, the gesture detection device 70 may be configured to detect only a gesture that triggers an operation of the rear door 32. In other words, the front door 31 may not be opened and closed by a gesture in the embodiment described above. In this case, the rear opening portion 22 corresponds to an “opening portion”, and the rear door 32 corresponds to a “door”. In this case, in a state where the user faces a left side surface of the vehicle 10, for example, the right hand corresponds to a “predetermined body part”, the right hand position PRh corresponds to a “predetermined position”, the opening direction of the rear door 32 corresponds to a “predetermined direction” corresponding to the opening direction of the rear door 32, and the right outward gesture corresponds to a “predetermined gesture”.

For example, the gesture detection device 70 may be configured to detect only a gesture that triggers an operation of the front door 31. In other words, the rear door 32 may not be opened and closed by a gesture in the embodiment described above. In this case, the front opening portion 21 corresponds to the “opening portion”, and the front door 31 corresponds to the “door”. In this case, in a state where the user faces the left side surface of the vehicle 10, for example, the left hand corresponds to the “predetermined body part”, the left hand position PLh corresponds to the “predetermined position”, the opening direction of the front door 31 corresponds to the “predetermined direction” corresponding to the opening direction of the front door 31, and the left outward gesture corresponds to the “predetermined gesture”.
The vehicle body 20 may include only one opening portion of the front opening portion 21 and the rear opening portion 22, and the vehicle 10 may include only one door of the front door 31 and the rear door 32, which opens and closes the one opening portion. In this case, the gesture detection device 70 may detect at least a gesture for opening the door that opens and closes the one opening portion.
The position of the camera 50 can be changed as appropriate. When a plurality of cameras 50 are used, the cameras 50 may be provided at both the front door 31 and the rear door 32.
The vehicle 10 may include a back door and a back camera that can image the rear of the vehicle 10 regardless of an opening and closing state of the back door. The vehicle body 20 may include an opening portion that opens to the rear and is opened and closed by the back door. The gesture detection device 70 may open and close the back door according to contents of a gesture made by a user. In this case, the opening portion that opens to the rear of the vehicle body 20 corresponds to the “opening portion”, and the back door corresponds to the “door”.

In the above configuration, when a right side of the opening portion is defined as a first opening portion and a left side of the opening portion is defined as a second opening portion, the back door may include a first door that opens and closes the first opening portion and a second door that opens and closes the second opening portion. The gesture detection device 70 may open and close the first door or open and close the second door according to contents of a gesture made by a user.
The gesture detection device 70 is not limited to a processing circuit that includes a CPU and a memory and executes software processing. For example, the gesture detection device 70 may include a dedicated hardware circuit that executes at least a part of various types of processing executed in the embodiment described above. Examples of the dedicated hardware circuit include an ASIC. The ASIC is an abbreviation for “application specific integrated circuit”. That is, the gesture detection device 70 may have any one of the following configurations (a) to (c).
   (a) A processing circuit that includes a processing device that executes all of the above processing according to a program, and a program storage device such as a ROM that stores the program.
   (b) A processing circuit that includes a processing device and a program storage device that execute a part of the above processing according to a program, and a dedicated hardware circuit that executes remaining processing.
   (c) A processing circuit that includes a dedicated hardware circuit for executing all of the above processing.

Here, there may be a plurality of software execution devices including a processing device and a program storage device, and a plurality of dedicated hardware circuits. The same applies to the door control device 60.

### Summary of Present Embodiments

The present embodiment includes at least the following configurations.

A gesture detection device (70) according to the present embodiment is applied to a vehicle (10) including a vehicle body (20) having an opening portion (21, 22), a door (31, 32) configured to open and close the opening portion (21, 22), a camera (50) configured to image a user who faces the opening portion (21, 22), and a door drive unit (41, 42) configured to drive the door (31, 32), and the gesture detection device (70) detects a gesture that triggers an operation of the door (31, 32) and is made by the user using a predetermined body part. A body part of the user different from the predetermined body part is a reference body part. The gesture detection device (70) includes a position acquisition unit (73) configured to acquire a predetermined position (PRh, PLh) which is a position of the predetermined body part and a reference position (PN, PRs, PLs) which is a position of the reference body part in an image captured by the camera (50), a direction determination unit (74) configured to determine whether the user faces the opening portion (21, 22) based on the reference position (PN, PRs, PLs) in the image, and a gesture determination unit (75) configured to determine whether the user has made a gesture based on changes of the predetermined position (PRh, PLh) and the reference position (PN, PRs, PLs) in a plurality of the images captured at different imaging times, when the direction determination unit (74) determines that the user faces the opening portion (21, 22). The gesture determination unit (75) determines that the user has made a predetermined gesture for opening at least the door (31, 32), when the predetermined position (PRh, PLh) is moved relative to the reference position (PN, PRs, PLs) in a predetermined direction corresponding to an opening direction of the door (31, 32).

When it can be determined that the user faces the opening portion, the gesture detection device determines whether the user has made a gesture. Specifically, the gesture detection device determines that the user has made a predetermined gesture when the user moves the predetermined body part in the predetermined direction. Therefore, the user can open at least the door by moving the predetermined body part in the predetermined direction corresponding to the opening direction of the door.

When the user makes a gesture while approaching the vehicle, the predetermined position in the image is changed because the user makes the gesture and the user approaches the vehicle. In terms of this point, the gesture detection device determines whether the user has made a gesture based on a change of the predetermined position relative to the reference position. Therefore, the gesture detection device can accurately determine whether the user has made a gesture when the user makes a gesture while approaching the vehicle and when the user stops and makes a gesture. Therefore, the gesture detection device can improve convenience for a user.

In the present embodiment, the opening portion (21, 22) may be a first opening portion (22), the door (31, 32) may be a first door (32), the predetermined body part may be a first body part, the predetermined position (PRh, PLh) may be a first position (PRh), the predetermined direction may be a first direction, the predetermined gesture may be a first gesture, and a body part of the user different from the first body part and the reference body part may be a second body part. The vehicle body (20) may further include a second opening portion (21) adjacent to the first opening portion (22). The vehicle (10) may further include a second door (31) driven by the door drive unit (41, 42) and configured to open and close the second opening portion (21). The camera (50) may be further configured to image the user who faces the second opening portion (21). The position acquisition unit (73) may be further configured to acquire a second position (PLh) that is a position of the second body part in the image captured by the camera (50). The direction determination unit (74) may be further configured to determine whether the user faces the second opening portion (21), based on the reference position (PN, PRs, PLs) in the image. The gesture determination unit (75) may be further configured to determine whether the user has made a gesture based on changes of the second position (PLh) and the reference position (PN, PRs, PLs) in a plurality of the images captured at different imaging times, when the direction determination unit (74) determines that the user faces the first opening portion (22) and the second opening portion (21), and configured to determine that the user has made a second gesture for opening at least the second door (31), when the second position (PLh) is moved relative to the reference position (PN, PRs, PLs) in a second direction corresponding to an opening direction of the second door (31).

When it can be determined that the user faces the first opening portion and the second opening portion, the gesture detection device determines whether the user has made a gesture. Specifically, the gesture detection device determines that the user has made the second gesture when the user moves the second body part in the second direction. Therefore, the user can open at least the second door by moving the second body part in the second direction corresponding to the opening direction of the second door.

When the user makes a gesture while approaching the vehicle, the first position and the second position in the image are changed because the user makes the gesture and the user approaches the vehicle. In terms of this point, the gesture detection device determines whether the user has made a gesture based on changes of the first position and the second position relative to the reference position. Therefore, the gesture detection device can accurately determine whether the user has made a gesture when the user makes a gesture while approaching the vehicle and when the user stops and makes a gesture. Therefore, the gesture detection device can improve convenience for a user.

In the present embodiment, in a state where the user faces the first opening portion (22) and the second opening portion (21), the first opening portion (22) may face a right half body of the user, the second opening portion (21) may face a left half body of the user, the first body part may be a right hand of the user, and the second body part may be a left hand of the user.

When the user faces the first opening portion and the second opening portion, the user can open a door positioned on a right front side with a gesture using the right hand. Further, the user can open a door positioned on a left front side with a gesture using the left hand. Therefore, the gesture detection device can further improve convenience for a user.

In the present embodiment, the gesture determination unit (75) may be further configured to determine that the user has made the first gesture when the first position (PRh) is moved in the first direction and then is moved in a direction opposite to the first direction relative to the reference position (PN, PRs, PLs), and determine that the user has made the second gesture when the second position (PLh) is moved in the second direction and then is moved in a direction opposite to the second direction relative to the reference position (PN, PRs, PLS).

The gesture detection device can accurately determine whether the user has made the first gesture as compared with, for example, a case where it is determined that the user has made the first gesture only by moving the first position in the first direction. Similarly, the gesture detection device can accurately determine whether the user has made the second gesture as compared with, for example, a case where it is determined that the user has made the second gesture only by moving the second position in the second direction. Therefore, the gesture detection device is less likely to erroneously determine the first gesture and the second gesture.

In the present embodiment, the gesture determination unit (75) may be further configured to determine that the user has made the first gesture when the first position (PRh) is moved in the first direction and then is stopped relative to the reference position (PN, PRs, PLs), and determine that the user has made the second gesture when the second position (PLh) is moved in the second direction and then is stopped relative to the reference position (PN, PRs, PLs).

The gesture detection device can accurately determine whether the user has made the first gesture as compared with, for example, a case where it is determined that the user has made the first gesture only by moving the first position in the first direction. Similarly, the gesture detection device can accurately determine whether the user has made the second gesture as compared with, for example, a case where it is determined that the user has made the second gesture only by moving the second position in the second direction. Therefore, the gesture detection device is less likely to erroneously determine the first gesture and the second gesture.

In the present embodiment, the first gesture may include a third gesture for opening only the first door (32) and a fourth gesture that is a gesture different from the third gesture and is a gesture for opening the first door (32) and the second door (31). The second gesture may include a fifth gesture for opening only the second door (31) and a sixth gesture that is a gesture different from the fifth gesture and is a gesture for opening the first door (32) and the second door (31). The gesture determination unit (75) may be further configured to determine that the user has made the third gesture when the first position (PRh) is moved in the first direction and then is moved in a direction opposite to the first direction relative to the reference position (PN, PRs, PLs), determine that the user has made the fourth gesture when the first position (PRh) is moved in the first direction and then is stopped relative to the reference position (PN, PRs, PLs), determine that the user has made the fifth gesture when the second position (PLh) is moved in the second direction and then is moved in a direction opposite to the second direction relative to the reference position (PN, PRs, PLs), and determine that the user has made the sixth gesture when the second position (PLh) is moved in the second direction and then is stopped relative to the reference position (PN, PRs, PLs).

The user can select whether to open only the first door or to open both the first door and the second door by selectively using the third gesture and the fourth gesture using the first body part. The user can select whether to open only the second door or to open both the first door and the second door by selectively using the fifth gesture and the sixth gesture using the second body part. Therefore, the gesture detection device can further improve convenience for a user.

In the present embodiment, the reference body part may include a right shoulder and a left shoulder of the user, and the reference position (PN, PRs, PLs) may include a right shoulder position (PRs) and a left shoulder position (PLs) of the user. The direction determination unit (74) may be further configured to determine whether the user faces the first opening portion (22) and the second opening portion (21) based on a shoulder width (Ls) that is a distance between the right shoulder position (PRs) and the left shoulder position (PLs) of the user in the image.

When the user faces the first opening portion and the second opening portion, the shoulder width is likely to be long. On the other hand, when the user does not face the first opening portion and the second opening portion, there is a high possibility that the shoulder width is short or the shoulder width is not correctly calculated. In terms of this point, the gesture detection device determines whether the user faces the first opening portion and the second opening portion based on the shoulder width. Therefore, the gesture detection device can accurately determine whether the user faces the first opening portion and the second opening portion.

In the present embodiment, the first opening portion (22) may be opened in a side surface of the vehicle body (20), the second opening portion (21) may be opened in front of the first opening portion (22) in the side surface of the vehicle body (20). The first door (32) may be a rear door (32), the second door (31) may be a front door (31), the first direction may be a direction the same as the opening direction of the first door (32), and the second direction may be a direction the same as the opening direction of the second door (31).

In the gesture detection device, the first direction is a direction the same as the opening direction of the first door, and the second direction is a direction the same as the opening direction of the second door. Therefore, it is easy for the user to intuitively understand a movement direction of the first body part when making the first gesture and a movement direction of the second body part when making the second gesture.

In the present embodiment, the camera (50) and the position acquisition unit (73) may be installed between the first opening portion (22) and the second opening portion (21) in the vehicle body (20) in an arrangement direction of the first opening portion (22) and the second opening portion (21). The first position (PRh), the second position (PLh), and the reference position (PN, PRs, PLs) may be acquired from the image captured by the camera (50).

Since the camera is installed between the first opening portion and the second opening portion, when the camera images the user who faces the first opening portion and the second opening portion, a right half body and a left half body of the user tend to be evenly reflected in an image. Therefore, the gesture detection device can easily acquire the first position and the second position when the first body part is selected from one of the right half body and the left half body of the user and the second body part is selected from the other one of the right half body and the left half body of the user.

In the present embodiment, the first gesture may be a first opening gesture, and the second gesture may be a second opening gesture. The gesture determination unit (75) may be further configured to determine that the user has made a first closing gesture for closing at least the first door (32) when the first position (PRh) is moved relative to the reference position (PN, PRs, PLs) in the direction opposite to the first direction, and determine that the user has made a second closing gesture for closing at least the second door (31) when the second position (PLh) is moved relative to the reference position (PN, PRs, PLs) in the direction opposite to the second direction.

The user can close at least the first door by moving the first body part in the direction opposite to the first direction. The user can close at least the second door by moving the second body part in the direction opposite to the second direction. In this manner, the user can selectively open and close the first door and the second door by selectively using a gesture.

A gesture detection method according to the present embodiment is applied to a vehicle (10) including a vehicle body (20) having an opening portion (21, 22), a door (31, 32) configured to open and close the opening portion (21, 22), a camera (50) configured to image a user who faces the opening portion (21, 22), and a door drive unit (41, 42) configured to drive the door (31, 32), and the gesture detection method detects a gesture that triggers an operation of the door (31, 32) and is made by the user using a predetermined body part. A body part of the user different from the predetermined body part is a reference body part. The gesture detection method includes a position acquisition step of acquiring a predetermined position (PRh, PLh) which is a position of the predetermined body part and a reference position (PN, PRs, PLs) which is a position of the reference body part in an image captured by the camera (50), a direction determination step of determining whether the user faces the opening portion (21, 22) based on the reference position (PN, PRs, PLs) in the image, and a gesture determination step of determining whether the user has made a gesture based on changes of the predetermined position (PRh, PLh) and the reference position (PN, PRs, PLs) in a plurality of the images captured at different imaging times, when it is determined in the direction determination step that the user faces the opening portion (21, 22). In the gesture determination step, it is determined that the user has made a gesture for opening at least the door (31, 32) when the predetermined position (PRh, PLh) is moved relative to the reference position (PN, PRs, PLs) in a predetermined direction corresponding to an opening direction of the door (31, 32).

The gesture detection method according to the present embodiment can obtain the same effect as the gesture detection device described above.

In the present embodiment, the opening portion (21, 22) may be a first opening portion (22), the door (31, 32) may be a first door (32), the predetermined body part may be a first body part, the predetermined position (PRh, PLh) may be a first position (PRh), the predetermined direction may be a first direction, the predetermined gesture may be a first gesture, and a body part of the user different from the first body part and the reference body part may be a second body part. The vehicle body (20) may further include a second opening portion (21) adjacent to the first opening portion (22). The vehicle body (20) may further include a second door (31) driven by the door drive unit (41, 42) and configured to open and close the second opening portion (21). The camera (50) may be further configured to image the user who faces the second opening portion (21). The position acquisition step may include acquiring a second position (PLh) which is a position of the second body part in the image captured by the camera (50). The direction determination step may include determining whether the user faces the second opening portion (21), based on the reference position (PN, PRs, PLs) in the image. The gesture determination step may include determining whether the user has made a gesture based on changes of the second position (PLh) and the reference position (PN, PRs, PLs) in a plurality of the images captured at different imaging times, when it is determined that the user faces the first opening portion (22) and the second opening portion (21), and determining that the user has made a second gesture for opening at least the second door (31), when the second position (PLh) is moved relative to the reference position (PN, PRs, PLs) in a second direction corresponding to an opening direction of the second door (31).

According to the above configuration, the same effects as those of the corresponding gesture detection device can be obtained.

### REFERENCE SIGNS LIST

10: vehicle
20: vehicle body
21: front opening portion (second opening portion)
22: rear opening portion (first opening portion)
23: center pillar
31: front door (second door)
32: rear door (first door)
41: front door drive unit
42: rear door drive unit
50: camera
60: door control device
70: gesture detection device
71: storage unit
72: image acquisition unit
73: position acquisition unit
74: direction determination unit
75: gesture determination unit
76: output unit
PN: neck position
PRh: right hand position
PLh: left hand position
PRs: right shoulder position
PLs: left shoulder position
PRt: right foot tip position
PLt: left foot tip position

1. A gesture detection device that is applied to a vehicle including a vehicle body having an opening portion, a door configured to open and close the opening portion, a camera configured to image a user who faces the opening portion, and a door drive unit configured to drive the door, and that detects a gesture that triggers an operation of the door and is made by the user using a predetermined body part,
a body part of the user different from the predetermined body part being a reference body part,
the gesture detection device comprising:
a position acquisition unit configured to acquire a predetermined position which is a position of the predetermined body part and a reference position which is a position of the reference body part in an image captured by the camera;
a direction determination unit configured to determine whether the user faces the opening portion based on the reference position in the image; and
a gesture determination unit configured to determine whether the user has made a gesture based on changes of the predetermined position and the reference position in a plurality of the images captured at different imaging times, when the direction determination unit determines that the user faces the opening portion, wherein
the gesture determination unit determines that the user has made a predetermined gesture for opening at least the door, when the predetermined position is moved relative to the reference position in a predetermined direction corresponding to an opening direction of the door.

2. The gesture detection device according to claim 1, wherein
the opening portion is a first opening portion, the door is a first door, the predetermined body part is a first body part, the predetermined position is a first position, the predetermined direction is a first direction, the predetermined gesture is a first gesture, and a body part of the user different from the first body part and the reference body part is a second body part,
the vehicle body further includes a second opening portion adjacent to the first opening portion,
the vehicle further includes a second door driven by the door drive unit and configured to open and close the second opening portion,
the camera is further configured to image the user who faces the second opening portion,
the position acquisition unit is further configured to acquire a second position which is a position of the second body part in the image captured by the camera,
the direction determination unit is further configured to determine whether the user faces the second opening portion, based on the reference position in the image, and
the gesture determination unit is further configured to
determine whether the user has made a gesture based on changes of the second position and the reference position in a plurality of the images captured at different imaging times, when the direction determination unit determines that the user faces the first opening portion and the second opening portion, and
determine whether the user has made a second gesture for opening at least the second door, when the second position is moved relative to the reference position in a second direction corresponding to an opening direction of the second door.

3. The gesture detection device according to claim 2, wherein
in a state where the user faces the first opening portion and the second opening portion,
the first opening portion faces a right half body of the user, and the second opening portion faces a left half body of the user, and
the first body part is a right hand of the user, and the second body part is a left hand of the user.

4. The gesture detection device according to claim 2, wherein
the gesture determination unit is further configured to
determine that the user has made the first gesture when the first position is moved in the first direction and then is moved in a direction opposite to the first direction relative to the reference position, and
determine that the user has made the second gesture when the second position is moved in the second direction and then is moved in a direction opposite to the second direction relative to the reference position.

5. The gesture detection device according to claim 2, wherein
the gesture determination unit is further configured to
determine that the user has made the first gesture when the first position is moved in the first direction and then is stopped relative to the reference position, and
determine that the user has made the second gesture when the second position is moved in the second direction and then is stopped relative to the reference position.

6. The gesture detection device according to claim 2, wherein
the first gesture includes a third gesture for opening only the first door and a fourth gesture that is a gesture different from the third gesture and is a gesture for opening the first door and the second door,
the second gesture includes a fifth gesture for opening only the second door and a sixth gesture that is a gesture different from the fifth gesture and is a gesture for opening the first door and the second door, and
the gesture determination unit is further configured to
determine that the user has made the third gesture when the first position is moved in the first direction and then is moved in a direction opposite to the first direction relative to the reference position,
determine that the user has made the fourth gesture when the first position is moved in the first direction and then is stopped relative to the reference position,
determine that the user has made the fifth gesture when the second position is moved in the second direction and then is moved in a direction opposite to the second direction relative to the reference position, and
determine that the user has made the sixth gesture when the second position is moved in the second direction and then is stopped relative to the reference position.

7. The gesture detection device according to claim 2, wherein
the reference body part includes a right shoulder and a left shoulder of the user,
the reference position includes a right shoulder position and a left shoulder position of the user, and
the direction determination unit is further configured to determine whether the user faces the first opening portion and the second opening portion based on a shoulder width that is a distance between the right shoulder position and the left shoulder position of the user in the image.

8. The gesture detection device according to claim 2, wherein
the first opening portion opens in a side surface of the vehicle body,
the second opening portion opens in front of the first opening portion in the side surface of the vehicle body,
the first door is a rear door,
the second door is a front door,
the first direction is a direction the same as an opening direction of the first door, and
the second direction is a direction the same as an opening direction of the second door.

9. The gesture detection device according to claim 2, wherein
the camera is installed between the first opening portion and the second opening portion on the vehicle body in an arrangement direction of the first opening portion and the second opening portion, and
the position acquisition unit is further configured to acquire the first position, the second position, and the reference position from the image captured by the camera.

10. The gesture detection device according to claim 2, wherein
the first gesture is a first opening gesture and the second gesture is a second opening gesture, and
the gesture determination unit is further configured to
determine that the user has made a first closing gesture for closing at least the first door when the first position is moved relative to the reference position in a direction opposite to the first direction, and
determine that the user has made a second closing gesture for closing at least the second door when the second position is moved relative to the reference position in a direction opposite to the second direction.

11. A gesture detection method that is applied to a vehicle including a vehicle body having an opening portion, a door configured to open and close the opening portion, a camera configured to image a user who faces the opening portion, and a door drive unit configured to drive the door, and that detects a gesture that triggers an operation of the door and is made by the user using a predetermined body part,
a body part of the user different from the predetermined body part being a reference body part,
the gesture detection method comprising:
a position acquisition step of acquiring a predetermined position which is a position of the predetermined body part and a reference position which is a position of the reference body part in an image captured by the camera;
a direction determination step of determining whether the user faces the opening portion based on the reference position in the image; and
a gesture determination step of determining whether the user has made a gesture based on changes of the predetermined position and the reference position in a plurality of the images captured at different imaging times, when it is determined in the direction determination step that the user faces the opening portion, wherein
the gesture determination step includes determining that the user has made a predetermined gesture for opening at least the door, when the predetermined position is moved relative to the reference position in a predetermined direction corresponding to an opening direction of the door.

12. The gesture detection method according to claim 11, wherein
the opening portion is a first opening portion, the door is a first door, the predetermined body part is a first body part, the predetermined position is a first position, the predetermined direction is a first direction, the predetermined gesture is a first gesture, and a body part of the user different from the first body part and the reference body part is a second body part,
the vehicle body further includes a second opening portion adjacent to the first opening portion,
the vehicle body further includes a second door driven by the door drive unit and configured to open and close the second opening portion,
the camera is further configured to image the user who faces the second opening portion,
the position acquisition step includes acquiring a second position which is a position of the second body part in the image captured by the camera,
the direction determination step includes determining whether the user faces the second opening portion based on the reference position in the image, and
the gesture determination step includes
determining whether the user has made a gesture based on changes of the second position and the reference position in a plurality of the images captured at different imaging times, when it is determined that the user faces the first opening portion and the second opening portion, and
determining whether the user has made a second gesture for opening at least the second door, when the second position is moved relative to the reference position in a second direction corresponding to an opening direction of the second door.
